(19) United States
(12) Patent Application Publication
(10) Pub. No.: US 2025/0310647 A1
(43) Pub. Date: Oct. 2, 2025

(54) IMAGE PROCESSING APPARATUS, INFORMATION PROCESSING APPARATUS, IMAGE PROCESSING METHOD, AND STORAGE MEDIUM

(71) Applicant: NEC Corporation, Tokyo (JP)

(72) Inventors: Taku Fujitomi, Tokyo (JP); Naoya Sogi, Tokyo (JP); Makoto Terao, Tokyo (JP)

(73) Assignee: NEC Corporation, Tokyo (JP)

(21) Appl. No.: 19/002,059

(22) Filed: Dec. 26, 2024

(30) Foreign Application Priority Data
Mar. 28, 2024 (JP) 2024-054402

(51) Int. Cl. H04N 23/695; H04N 23/61; H04N 23/68

(52) U.S. Cl. CPC H04N 23/695; H04N 23/61; H04N 23/6811; H04N 23/6812

(57) ABSTRACT

Tilt correction is suitably carried out for a camera image. An image processing apparatus includes: a first acquisition unit that acquires a camera image that has been captured by a camera which is attached to a gimbal; a second acquisition unit that acquires a tilt angle of the camera with reference to at least one selected from the group consisting of the camera image and gimbal information which includes a tilt of the gimbal; and a tilt correction unit that generates a tilt-corrected image by applying, to the camera image, a tilt correction process which is carried out with reference to the tilt angle of the camera.

This Nonprovisional application claims priority under 35 U.S.C. § 119 on Patent Application No. 2024-054402 filed in Japan on Mar. 28, 2024, the entire contents of which are hereby incorporated by reference.

### TECHNICAL FIELD

The present disclosure relates to an image processing apparatus, an information processing apparatus, an image processing method, and a storage medium.

### Background Art

There have been known techniques for acquiring images captured by a camera which is attached to a gimbal and using the images in various applications. For example, Patent Literature 1 discloses a technique for utilizing data captured by a camera which is attached to a drone via a gimbal.

### CITATION LIST

### Patent Literature

### Patent Literature 1

International publication No. WO2021-256464

### SUMMARY OF INVENTION

### Technical Problem

The use of a gimbal is expected to keep the attitude of a camera as horizontal as possible. However, in reality, the use of the gimbal does not always make it possible to keep the attitude of the camera horizontal due to, for example, the presence of a limit to an angle of the gimbal which enables the camera to be maintained horizontal. Therefore, in the technique described in Patent Literature 1, a process carried out in a case where the camera which is attached to the gimbal is tilted becomes a problem.

The present disclosure has been made in view of the above problem, and an example object of the present disclosure is to provide a technique of making it possible to suitably carry out tilt correction for a camera image that has been captured by a camera which is attached to a gimbal.

### Solution to Problem

An image processing apparatus in accordance with an example aspect of the present disclosure includes at least one first processor, the at least one first processor carrying out: a first acquisition process for acquiring a camera image that has been captured by a camera which is attached to a gimbal; a second acquisition process for acquiring a tilt angle of the camera with reference to at least one selected from the group consisting of the camera image and gimbal information which includes a tilt of the gimbal; and a tilt correction process for generating a tilt-corrected image by applying, to the camera image, tilt correction which is carried out with reference to the tilt angle of the camera.

An information processing apparatus in accordance with an example aspect of the present disclosure includes: the image processing apparatus; and at least one second processor, the at least one second processor carrying out: an interpolation process for generating an interpolated image by interpolating the tilt-corrected image; an image recognition process with respect to the interpolated image; and an output process for outputting a result of the image recognition process.

An information processing apparatus in accordance with an example aspect of the present disclosure includes: the image processing apparatus; at least one second processor, the at least one second processor carrying out: an image recognition process with respect to a tilt-corrected image; and an output process for outputting a result of the image recognition process.

An image processing method in accordance with an example aspect of the present disclosure includes: acquiring a camera image that has been captured by a camera which is attached to a gimbal; acquiring a tilt angle of the camera with reference to at least one selected from the group consisting of the camera image and gimbal information which includes a tilt of the gimbal; and generating a tilt-corrected image by applying, to the camera image, a tilt correction process which is carried out with reference to the tilt angle of the camera.

Note that the information processing apparatus in accordance with each aspect may be realized by a computer. In this case, the scope of the present invention also includes: a program causing the information processing apparatus to be realized by the computer by causing the computer to operate as each means of the information processing apparatus; and a computer-readable storage medium storing the program.

### Advantageous Effects of Invention

An example aspect of the present disclosure brings about an example effect of making it possible to suitably carry out tilt correction for a camera image that has been captured by a camera which is attached to a gimbal.

### BRIEF DESCRIPTION OF DRAWINGS

FIG. 1 is a block diagram illustrating a configuration of an image processing apparatus in accordance with the present disclosure.

FIG. 2 is a flowchart illustrating a flow of an image processing method in accordance with the present disclosure.

FIG. 3 is a block diagram illustrating a configuration of an information processing system in accordance with the present disclosure.

FIG. 4 is a diagram for describing an example of a process carried out by the information processing system in accordance with the present disclosure.

FIG. 5 is a diagram for describing an example of a process carried out by the information processing system in accordance with the present disclosure.

FIG. 6 is a diagram for describing an example of a process carried out by the information processing system in accordance with the present disclosure.

FIG. 7 is a diagram for describing an example of a process carried out by the information processing system in accordance with the present disclosure.

FIG. 8 is a diagram for describing an example of a process carried out by the information processing system in accordance with the present disclosure.

FIG. 9 is a diagram for describing an example of output carried out by the information processing system in accordance with the present disclosure.

FIG. 10 is a block diagram illustrating a configuration of a computer that functions as an information processing apparatus in accordance with the present disclosure.

### DESCRIPTION OF EMBODIMENTS

The example embodiments of the present invention will be exemplified in the following description. It should be noted that the present invention is not limited to the example embodiments described below, but may be altered in various ways by a skilled person within the scope of the claims. For example, any example embodiment derived by appropriately combining technical means employed in the example embodiments described below can also be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment which is an example of an embodiment of the present invention will be described in detail with reference to the drawings. The present example embodiment is a basic form of each example embodiment described later. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### Configuration of Image Processing Apparatus 1

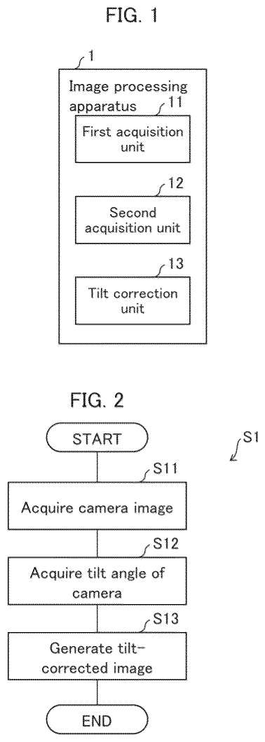

The following will describe a configuration of an image processing apparatus 1 in accordance with the present example embodiment with reference to FIG. 1. FIG. 1 is a block diagram illustrating the configuration of the image processing apparatus 1 in accordance with the present example embodiment. As illustrated in FIG. 1, the image processing apparatus 1 includes a first acquisition unit 11, a second acquisition unit 12, and a tilt correction unit 13.

### First Acquisition Unit 11

The first acquisition unit 11 acquires a camera image. Here, the camera image is, as an example, an image that has been captured by a camera which is attached to a gimbal. As an example, the first acquisition unit 11 acquires the camera image from the camera via a wired or wireless communication path. Alternatively, a configuration in which a camera image from the camera is temporarily stored in a storage section, and the first acquisition unit 11 acquires the camera image from the storage section may be employed. The term “gimbal” is merely an example of a designation of a mechanism for stabilizing a camera, and this term is not intended to limit the present example embodiment. The gimbal may be expressed as, for example, “stabilizer”, “electrically powered stabilizer”, or the like, and aspects using these terms are also included in the present example embodiment.

### Second Acquisition Unit 12

The second acquisition unit 12 acquires a tilt angle of the camera with reference to at least one selected from the group consisting of the camera image and gimbal information which includes a tilt of the gimbal. As an example, the second acquisition unit 12 may be configured to derive the tilt angle of the camera with reference to the camera image.

Alternatively, the second acquisition unit 12 may be configured to derive the tilt angle of the camera with reference to the tilt of the gimbal. Further, the second acquisition unit 12 may be configured to acquire the tilt angle of the camera further with reference to sensing data from an acceleration sensor which is attached to the camera or the gimbal or from a gyro sensor which is attached to the camera or the gimbal.

### Tilt Correction Unit 13

The tilt correction unit 13 generates a tilt-corrected image by applying, to the camera image acquired by the first acquisition unit 11, a tilt correction process which is carried out with reference to the tilt angle of the camera acquired (derived) by the second acquisition unit 12. As an example, the tilt-corrected image may be configured to be presented to a user via a display unit (not illustrated) or may be configured to be input to an image recognition unit (not illustrated).

### Effect of Image Processing Apparatus 1

As described above, the image processing apparatus 1 in accordance with the present example embodiment employs a configuration in which:
a camera image that has been captured by a camera which is attached to a gimbal is acquired;
a tilt angle of the camera is acquired with reference to at least one selected from the group consisting of the camera image and gimbal information which includes a tilt of the gimbal; and
a tilt-corrected image is generated by applying, to the camera image, a tilt correction process which is carried out with reference to the tilt angle of the camera.

According to the above-described configuration, a tilt that can be included in the camera image having been captured by the camera which is attached to the gimbal is corrected with reference to at least one selected from the group consisting of the camera image and the gimbal information, and it is thus possible to suitably carry out tilt correction for the camera image.

### Flow of Image Processing Method S1

Next, a flow of an image processing method S1 in accordance with the present example embodiment will be described with reference to FIG. 2. FIG. 2 is a flowchart illustrating the flow of the image processing method S1. The image processing method S1, as illustrated in FIG. 2, includes a process (step) S11 for acquiring a camera image, a process (step) S12 for acquiring a tilt of a camera, and a process (step) S13 for generating a tilt-corrected image.

### Step S11

In step S11, the first acquisition unit 11 acquires a camera image. Here, the camera image is, as an example, an image that has been captured by a camera which is attached to a gimbal. Since a specific process carried out by the first acquisition unit 11 has been described above, the description thereof will be omitted here.

### Step S12

Next, in step S12, the second acquisition unit 12 acquires a tilt angle of the camera with reference to at least one selected from the group consisting of the camera image and gimbal information which includes a tilt of the gimbal. Since a specific process carried out by the second acquisition unit 12 has been described above, the description thereof will be omitted here.

### Step S13

Next, in step S13, the tilt correction unit 13 generates a tilt-corrected image by applying, to the camera image acquired by the first acquisition unit 11, a tilt correction process which is carried out with reference to the tilt angle of the camera acquired (derived) by the second acquisition unit 12.

### Effect of Image Processing Method S1

As described above, the image processing method S1 in accordance with the present example embodiment employs a configuration in which:
a camera image that has been captured by a camera which is attached to a gimbal is acquired;
a tilt angle of the camera is acquired with reference to at least one selected from the group consisting of the camera image and gimbal information which includes a tilt of the gimbal; and.
a tilt-corrected image is generated by applying, to the camera image, a tilt correction process which is carried out with reference to the tilt angle of the camera.

The above-described configuration brings about an effect similar to the effect brought about by the image processing apparatus 1.

### Second Example Embodiment

A second example embodiment which is an example of an embodiment of the present invention will be described in detail with reference to the drawings. The same reference numerals are given to constituent elements which have functions identical with those described in the above-described example embodiment, and descriptions as to such constituent elements are omitted as appropriate. The scope of the application of each technical means employed in the present example embodiment is not limited to the present example embodiment. That is, each technical means employed in the present example embodiment can also be employed in other example embodiments included in the present disclosure to the extent that no particular technical obstruction occurs. In addition, each technical means illustrated in the drawings which are referred to for the description of the present example embodiment can also be employed in other example embodiments included in the present disclosure to the extent that no particular technical obstruction occurs.

### Configuration of Information Processing System 100A

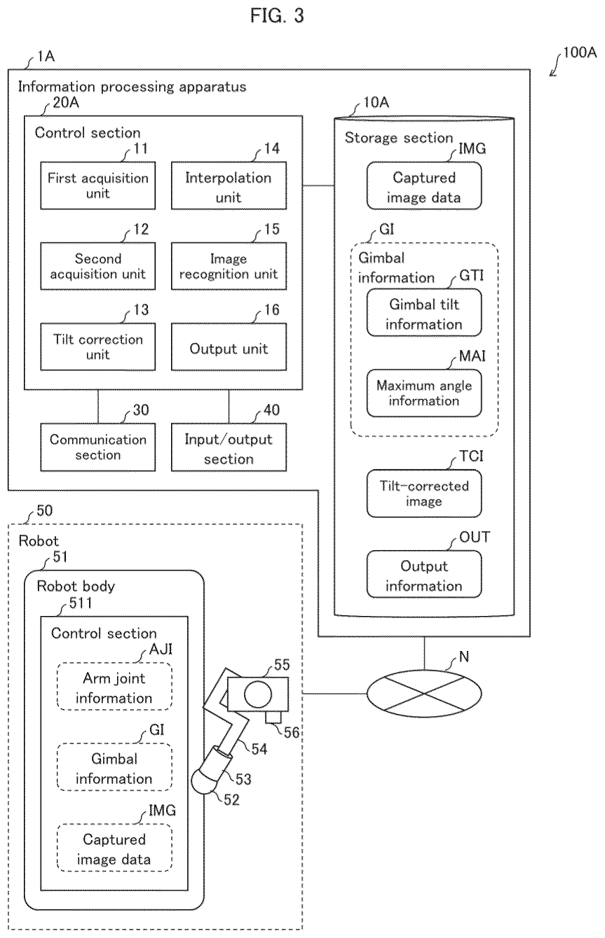

A configuration of an information processing system 100A in accordance with the present example embodiment will be described with reference to FIG. 3. FIG. 3 is a block diagram illustrating the configuration of the information processing system 100A. The information processing system 100A, as illustrated in FIG. 3, includes an information processing apparatus 1A and a robot 50 which is connected to the information processing apparatus 1A via a network N. Here, a specific configuration of the network N is not intended to limit the present example embodiment. As an example of the network N, a wireless local area network (LAN), a wired LAN, a wide area network (WAN), a public network, a mobile data communication network, or a combination of these networks can be used. Note that it is not essential that the information processing system 100A includes the robot 50, and the information processing apparatus 1A may be configured to acquire a camera image from a gimbal that is provided in an apparatus (for example, a drone or a self-propelled transport vehicle) other than a robot or from a camera that is attached to a gimbal which is supported by a person. In the following description, the term “information processing apparatus 1A” is not intended to limit the present example embodiment, and may be referred to as an image processing apparatus 1A or the like.

### Configuration of Robot 50

In the example illustrated in FIG. 3, the robot 50 includes a robot body 51. Further, as illustrated in FIG. 3, an arm 53 is attached to the robot body 51 via a joint 52. Further, a gimbal 54 is attached to the tip of the arm 53, and a camera 55 is attached to the gimbal 54. Further, as illustrated in FIG. 3, a sensor 56 may be directly or indirectly attached to the camera 55. The sensor 56 is, as an example, an acceleration sensor or a gyro sensor and is configured to be capable of detecting a tilt of the camera 55. Alternatively, the sensor 56 may be attached to the gimbal 54. However, the inclusion of the sensor 56 is not intended to limit the present example embodiment, and a configuration in which the sensor 56 is not included is also included in the present example embodiment.

Further, as illustrated in FIG. 3, the robot body 51 includes a control section 511. Here, the control section 511 includes, as an example, a control unit (not illustrated) that controls each section of the robot 50. Further, as illustrated in FIG. 3, the control section 511 acquires, from the control unit (not illustrated), the arm 53, or the joint 52, arm joint information AJI which includes at least one selected from the group consisting of an orientation of the arm 53 and a rotation angle of the joint 52. Then, the control section 511 provides the arm joint information AJI to the information processing apparatus 1A via a communication section (not illustrated). Further, as illustrated in FIG. 3, the control section 511 acquires, from the control unit (not illustrated), the arm 53, the joint 52, or the gimbal 54, gimbal information GI which includes a tilt of the gimbal 54. Then, the control section 511 provides the gimbal information GI to the information processing apparatus 1A via the communication section (not illustrated). Further, as illustrated in FIG. 3, the control section 511 acquires, from the camera 55, the following captured image data IMG that has been captured by the camera 55. Then, the control section 511 provides the captured image data IMG to the information processing apparatus 1A via the communication section (not illustrated). The captured image data IMG, as an example, may be a still image composed of one frame or may be a moving image composed of a plurality of frames. In addition, in a case where the captured image data IMG is a moving image, an image constituting each of the frames may also be referred to as a camera image.

Note that the arm joint information AJI and the gimbal information GI may be configured such that one of these two pieces of information includes the other one thereof or such that one of the two pieces of information substitutes the other one thereof. For example, a configuration can be employed in which the tilt of the gimbal 54 is derived from the arm joint information AJI by the control section 511 or the control section 20A. In such a configuration, the gimbal information GI may be substituted by the arm joint information AJI. a configuration may be Further, employed in which the gimbal information GI includes information (also referred to as maximum angle information) indicating a limit value of a relative angle between the camera 55 and the gimbal 54.

### Configuration of Information Processing Apparatus 1A

Next, a configuration of an information processing apparatus 1A in accordance with the present example embodiment will be described with reference to FIG. 3. As illustrated in FIG. 3, the information processing apparatus 1A includes a control section 20A, a storage section 10A, a communication section 30, and an input/output section 40.

### Communication Section 30

The communication section 30 communicates with an apparatus outside the information processing apparatus 1A. As an example, the communication section 30 communicates with the robot 50. The communication section 30 transmits, to the robot 50, data supplied from the control section 20A or supplies, to the control section 20A, data received from the robot 50.

Note that the data that the communication section 30 acquires from the robot 50 and provides to the control section 20A includes:
Arm joint information AJI;
Gimbal information GI; and
Captured image data IMG.

Since the arm joint information AJI, the gimbal information GI, and the captured image data IMG have been described above, the descriptions thereof will be omitted here.

### Input/Output Section 40

The input/output section 40 is configured to include at least one selected from input/output apparatuses such as a keyboard, a mouse, a display, a printer, and a touch panel. Alternatively, the input/output section 40 may be configured to be connected to input/output apparatuses such as a keyboard, a mouse, a display, a printer, and a touch panel. In the case of such a configuration, the input/output section 40 receives input of various kinds of information to the information processing apparatus 1A from the connected input apparatus. In addition, the input/output section 40 outputs various kinds of information to the connected output apparatus under the control of the control section 20A. The input/output section 40 includes, for example, an interface such as a universal serial bus (USB).

### Storage Section 10A

The storage section 10A stores various kinds of data that are to be referred to by the control section 20A and various kinds of data that have been generated by the control section 20A. As an example, the storage section 10A stores:
Captured image data IMG;
Gimbal information GI;
Tilt-corrected image TCI; and
Output information OUT.

Since the captured image data IMG has been described above, the description thereof will be omitted here. As described above, the gimbal information GI includes a tilt of the gimbal 54. Here, information indicating the tilt of the gimbal 54 is also expressed as gimbal tilt information GTI, as illustrated in FIG. 3. Further, as described above, the gimbal information GI may include information (maximum angle information MAI) indicating a limit value of a relative angle between the camera 55 and the gimbal 54.

The tilt-corrected image TCI refers to, as an example, an image in which the tilt is corrected by the tilt correction unit 13 which will be described later. The output information OUT refers to, as an example, information for output generated by the output unit 16 which will be described later. Specific examples of the tilt-corrected image TCI and the output information OUT will be described later.

### Control Section 20A

The control section 20A includes a first acquisition unit 11, a second acquisition unit 12, a tilt correction unit 13, an interpolation unit 14, an image recognition unit 15, and an output unit 16, as illustrated in FIG. 3. (First acquisition unit 11) The first acquisition unit 11 acquires a camera image (captured image data IMG) as in the first example embodiment. Here, as described above, the camera image (captured image data IMG) is, as an example, an image that has been captured by a camera 55 which is attached to a gimbal 54. Note that, in the present example embodiment as well, the term “gimbal” is merely an example of a designation of a mechanism for stabilizing a camera, and this term is not intended to limit the present example embodiment. The gimbal may be expressed as, for example, “stabilizer”, “electrically powered stabilizer”, or the like, and aspects using these terms are also included in the present example embodiment.

### Second Acquisition Unit 12

The second acquisition unit 12 acquires a tilt angle of the camera 55 with reference to at least one selected from the group consisting of the camera image (captured image data IMG) and the gimbal information GI which includes a tilt of the gimbal 54, as in the first example embodiment. As an example, the second acquisition unit 12 may be configured to derive the tilt angle of the camera 55 with reference to the camera image (captured image data IMG).

Alternatively, the second acquisition unit 12 may be configured to derive the tilt angle of the camera 55 with reference to the tilt of the gimbal 54. As an example, the second acquisition unit 12 may be configured to derive the tilt angle of the camera 55 with reference to:
The maximum angle information MAI indicating a limit value of a relative angle between the camera 55 and the gimbal 54; and.
The tilt of the gimbal 54.

Further, the second acquisition unit 12 may be configured to acquire the tilt angle of the camera 55 further with reference to sensing data from a sensor 56 (an acceleration sensor or a gyro sensor) which is attached to the camera 55 or the gimbal 54. A specific process carried out by the second acquisition unit 12 will be described later.

### Tilt Correction Unit 13

The tilt correction unit 13, as in the first example embodiment, generates a tilt-corrected image TCI by applying, to the camera image (captured image data IMG) acquired by the first acquisition unit 11, a tilt correction process which is carried out with reference to the tilt angle of the camera acquired (derived) by the second acquisition unit 12. As an example, the tilt-corrected image TCI may be configured to be visually presented to a user via the input/output section 40 or may be configured to be input to the image recognition unit 15 which is included in the control section 20A. A specific process carried out by the tilt correction unit 13 will be described later.

### Interpolation Unit 14

The interpolation unit 14 generates an interpolated image by applying an interpolation process to the tilt-corrected image TCI that has been generated by the tilt correction unit 13. A specific process carried out by the interpolation unit 14 will be described later.

### Image Recognition Unit 15

The image recognition unit 15 applies the image recognition process to at least one selected from the group consisting of:
The tilt-corrected image TCI that has been generated by the tilt correction unit 13; and.
The interpolated image that has been generated by the interpolation unit 14.

Here, as an example, the image recognition process can include a physical object detection process (object detection process). However, this is not intended to limit the present example embodiment. In addition, as an example, the image recognition process may be carried out with use of an image recognition model that has been trained with reference to an image group including a mask region corresponding to an outside-field-of-view region. A specific process carried out by the image recognition unit 15 will be described later.

### Output Unit 16

The output unit 16 presents information that has been derived by each of the above-described units included in the control section 20A to the user via the input/output section 40 or provides the information to another apparatus via the communication section 30. As an example, the output unit 16 visually presents at least one selected from the group consisting of the following images and information to the user via the input/output section 40 or provides the at least one selected from the group consisting of the following images and information to another apparatus via the communication section 30.
The tilt-corrected image TCI that has been generated by the tilt correction unit 13;
The interpolated image that has been generated by the interpolation unit 14; and.
Information indicating a result of the image recognition process carried out by the image recognition unit 15.

### Example 1 of Flow of Process Carried Out by Information Processing Apparatus 1A

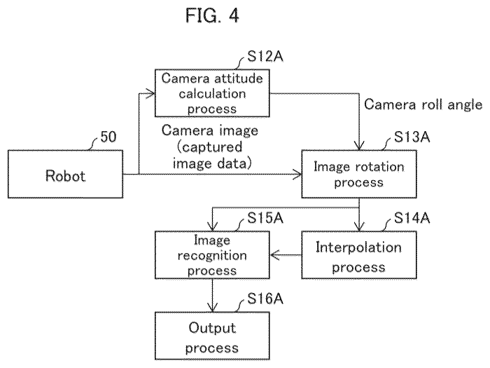

The following will describe an example of a flow of a process carried out by the information processing apparatus 1A with reference to FIGS. 4 to 7. Note that arrows in FIG. 4 each merely indicate an example of a direction in which data is moved. Alternatively, data may be moved in the opposite direction or may be moved between constituent elements other than the constituent components which are connected by the arrows.

### Step S12A

First, in step S12A, the second acquisition unit 12 carries out a camera attitude calculation process with reference to camera image (captured image data IMG) that has been acquired from the robot 50 by the first acquisition unit 11. In the camera attitude calculation process, as an example, the second acquisition unit 12 derives a tilt angle (a camera roll angle in FIG. 4) of the camera 55 described above. In this step, more specifically, the second acquisition unit 12 may be configured to:
apply image processing (edge detection processing as an example) to the camera image (captured image data IMG);
determine a vertical direction with reference to a detected edge; and
derive a tilt angle of the camera with reference to a tilt of the camera image (captured image data IMG) in the determined vertical direction.

For example, the second acquisition unit 12 may be configured to:
detect an edge of a store shelf or a corrugated cardboard box included in the camera image by applying the edge detection processing to the camera image; and
derive the tilt angle of the camera by determining in which direction the detected edge points in the camera image.

Alternatively, the second acquisition unit 12 may be configured to determine the tilt angle of the camera with reference to an output obtained from a model that has been trained to receive an image as an input and output a tilt angle of a camera which has captured the image by inputting the camera image (captured image data IMG) into the model. Here, as an example, the model can be trained with reference to training data that includes a set of an image and label data (training label) indicating a tilt angle of a camera which has captured the image. However, this is not intended to limit the present example embodiment. In addition, the above-described model may be, as an example, a model that has been obtained by deep learning using a convolutional neural network (CNN) or the like. However, this is not intended to limit the present example embodiment.

Alternatively, in this step, the second acquisition unit 12 may be configured to acquire the tilt angle of the camera further with reference to sensing data from the sensor 56 (an acceleration sensor or a gyro sensor) which is attached to the camera 55 or the gimbal 54.

In the example illustrated in FIG. 4, an example is presented in which the roll angle of the camera is calculated as the tilt angle of the camera in the camera attitude calculation process. However, the term “roll angle” is not intended to limit the present example embodiment and may include a tilt angle such as an angle expressed as a “pitch angle”.

### Step S13A

Next, in step S13A, the tilt correction unit 13 generates the tilt-corrected image TCI by applying, to the camera image (captured image data IMG) that has been acquired from the robot 50 by the first acquisition unit 11, an image rotation process which is carried out with reference to the tilt angle of the camera 55 that has been derived by the second acquisition unit 12.

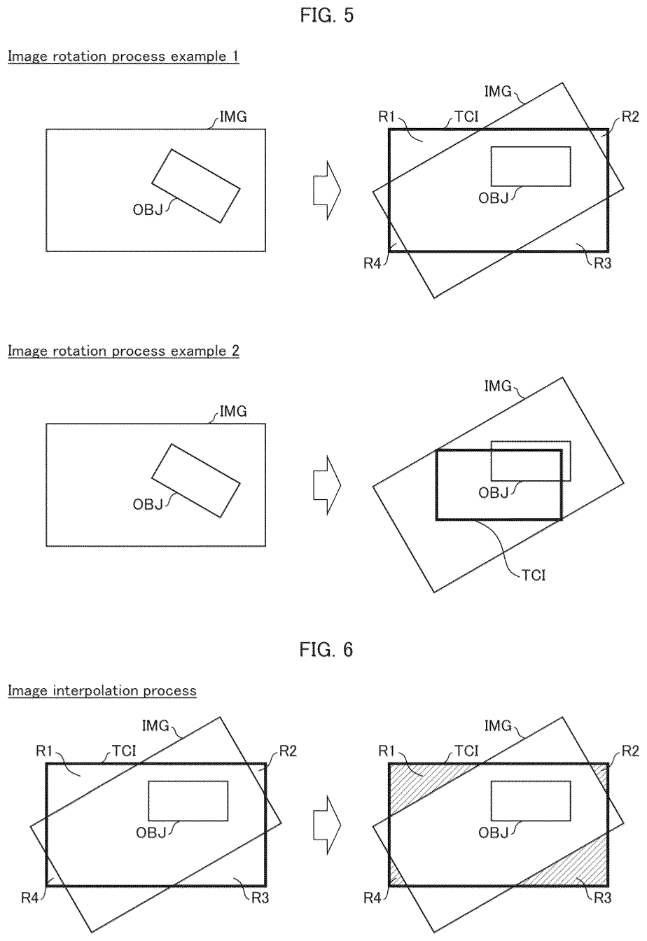

Example 1 of the image rotation process carried out by the tilt correction unit 13 in this step is illustrated in an upper part of FIG. 5. In the example illustrated in the upper part of FIG. 5, in the image rotation process, the tilt-corrected image TCI is generated by rotating the camera image (captured image data IMG) by a rotation angle corresponding to the tilt angle of the camera 55.

As illustrated in the upper part of FIG. 5, an image capture target object OBJ included in the camera image (captured image data IMG) has been imaged in a tilted position in the camera image (captured image data IMG). However, in the tilt-corrected image TCI, the image capture target object OBJ is not tilted. Meanwhile, as illustrated in the upper part of FIG. 5, as a result of the image rotation process in accordance with the present example, one or more outside-field-of-view regions (regions R1, R2, . . . in the example illustrated in the upper part of FIG. 5) can be included in the tilt-corrected image TCI. Here, the term “outside-field-of-view region” indicates a region that has not been included in the camera image (captured image data IMG). However, this term is not intended to limit the present example embodiment.

Example 2 of the image rotation process carried out by the tilt correction unit 13 in this step is illustrated in a lower part of FIG. 5. In the example illustrated in the lower part of FIG. 5, in the image rotation process, the tilt-corrected image TCI is generated by:
rotating the camera image (captured image data IMG) by a rotation angle corresponding to the tilt angle of the camera 55; and, further,.
applying enlargement processing, reduction processing, or cutout processing to the rotated image.

Here, as an example, the above-described enlargement processing, reduction processing, or cutout processing is carried out so that the outside-field-of-view region is not included in the tilt-corrected image TCI.

In the example illustrated in the lower part of FIG. 5, an image capture target object OBJ included in the camera image (captured image data IMG) has been imaged in a tilted position in the camera image (captured image data IMG). However, in the tilt-corrected image TCI, the image capture target object OBJ is not tilted. Further, as illustrated in the lower part of FIG. 5, as a result of the image rotation process in accordance with the present example, the above-described outside-field-of-view region is not included in the tilt-corrected image TCI.

In the example illustrated in the lower part of FIG. 5, as a result of the above-described enlargement processing, reduction processing, or cutout processing, a state may occur in which a part of the image capture target object OBJ that has been included in the camera image (captured image data IMG) is not included in the tilt-corrected image TCI. Therefore, it can be said that Example 1 is more preferable than Example 2 described above from the viewpoint of an image recognition process which will be described later. However, this is not intended to limit the present example embodiment.

### Step S14A

Next, in step S14A, the interpolation unit 14 generates an interpolated image by applying an interpolation process to the tilt-corrected image TCI that has been generated by the tilt correction unit 13 in step S13A.

As an example, the interpolation unit 14 generates, as the interpolated image, an image in which one or more outside-field-of-view regions (regions R1, R2, . . . illustrated in the upper part of FIG. 5) that have appeared in the tilt-corrected image TCI as a result of the image rotation process in step S13A are interpolated. As an example, the interpolation unit 14 may input the tilt-corrected image TCI to a trained interpolation model and acquire an interpolated image as an output of the interpolation model. Here, as an example, the interpolation model may be a model trained with use of training data that includes (i) an image which includes a missing region (also referred to as a missing image) and (ii) an image which does not include the missing region (original image) as correct answer data.

Alternatively, the interpolation model may be configured as a model called a generation model, an encoder/decoder model, or the like. As an example, such an interpolation model may be expressed as:
A model for interpolating an outside-field-of-view region by carrying out an image interpolation process that is conditioned by inside-field-of-view information included in the camera image (captured image data IMG).

In the example illustrated in FIG. 6, an interpolated image is generated in which one or more outside-field-of-view regions (regions R1, R2, . . . ) that have appeared in the tilt-corrected image TCI are interpolated. Here, oblique lines in the regions R1, R2, . . . in FIG. 6 indicate that the regions are occupied by (filled with) interpolation images.

By the interpolation unit 14 carrying out the interpolation process as described above, as an example, various example effects are obtained including the following effects.
Since data distribution of an interpolated image can be made close to data distribution of training data used by the image recognition unit which will be described later, the accuracy of image recognition by the image recognition unit is enhanced.
It is possible to present, to the user, an interpolated image which does not bring a feeling of strangeness.

However, as will be described later, the interpolation process in this step S14A is not an essential process in the present example embodiment, and a configuration in which the interpolation process is not carried out is also included in the present example embodiment.

### Step S15A

In step S15A, the image recognition unit 15 carries out an image recognition process with reference to at least one of the following:
The tilt-corrected image TCI that has been generated in step S13A; and
The interpolated image that has been generated in step S14A.

Hereinafter, the tilt-corrected image TCI and the interpolated image which are referred to by the image recognition unit 15 in this step are each also referred to as a target image.

As an example, in this step, the image recognition unit 15 applies a physical object detection process (object detection process) to the target image to output a result of the process. Here, the result of the process may be configured to include the position and type of one or more objects in the target image. Further, as an example, the image recognition unit 15 may be configured to carry out the physical object detection process with use of a physical object detection model that has been trained with reference to training data that includes (i) an image which includes one or more objects and (ii) the position and type of the object(s) in the image as a correct answer label.

In addition, in a case where the image recognition unit 15 carries out the image recognition process with reference to the tilt-corrected image TCI to which the interpolation process in step S14A is not applied, the physical object detection model may be a physical object detection model trained with reference to training data that includes (i) an image which includes one or more objects and which includes one or more outside-field-of-view regions as a mask region and (ii) the position and type of the object(s) in the image as a correct answer label.

In other words, the image recognition unit 15 may be configured to carry out the image recognition process with use of an image recognition model that has been trained with reference to an image group including a mask region corresponding to an outside-field-of-view region. Thus, with the configuration in which the image recognition process is carried out with use of the image recognition model that has been trained with reference to an image group including a mask region corresponding to an outside-field-of-view region, it is possible to suitably carry out the image recognition process even in the configuration in which the above-described interpolation process S14A is not included.

### Step S16A

In step S16A, the output unit 16 presents information that has been derived by each process described above to the user via the input/output section 40 or provides the information to another apparatus via the communication section 30. As an example, the output unit 16 visually presents at least one selected from the group consisting of the following images and information to the user via the input/output section 40 or provides the at least one selected from the group consisting of the following images and information to another apparatus via the communication section 30.
The tilt-corrected image TCI that has been generated by the tilt correction unit 13;
The interpolated image that has been generated by the interpolation unit 14; and.
Information indicating a result of the image recognition process carried out by the image recognition unit 15.

FIG. 7 illustrates an example of output information OUT which is displayed by the output unit 16 via a display provided in the input/output section 40 in this step. As illustrated in FIG. 7, the output information OUT includes:
Tilt-corrected image TCI (or interpolated image);
An object OBJ that has been detected in the tilt-corrected image TCI (or interpolated image) by the physical object detection process;
A bounding box (“BB” in FIG. 7) indicating the position of the object OBJ that has been specified in the physical object detection process; and
Information (“product A” in FIG. 7) indicating the type of the object OBJ that has been specified in the physical object detection process.

As described above, carried out in Example 1 of the flow described above are the following processes:
a camera image that has been captured by a camera which is attached to a gimbal is acquired;
the tilt angle of the camera is acquired with reference to the camera image (step S12A); and
a tilt-corrected image is generated by applying, to the camera image, a tilt correction process which is carried out with reference to the tilt angle of the camera (step S13A).

According to the above-described configuration, a tilt that can be included in the camera image having been captured by the camera which is attached to the gimbal is corrected with reference to the camera image, and it is thus possible to suitably carry out tilt correction for the camera image. As an example, a tilt in a camera image caused by the tilt of the camera which cannot be completely adjusted even with use of a gimbal can be suitably corrected.

In addition, in Example 1 of the flow described above, the image recognition process is carried out (step S15A) with reference to at least one of the following images:
The tilt-corrected image TCI that has been generated in step S13A; and.
The interpolated image that has been generated in step S14A.

Thus, it is possible to derive a suitable image recognition result.

### Example 2 of Flow of Process Carried Out by Information Processing Apparatus 1A

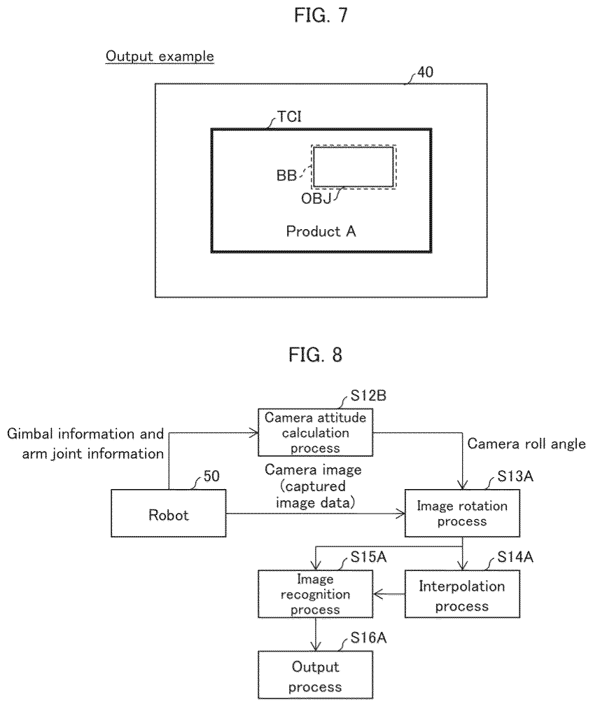

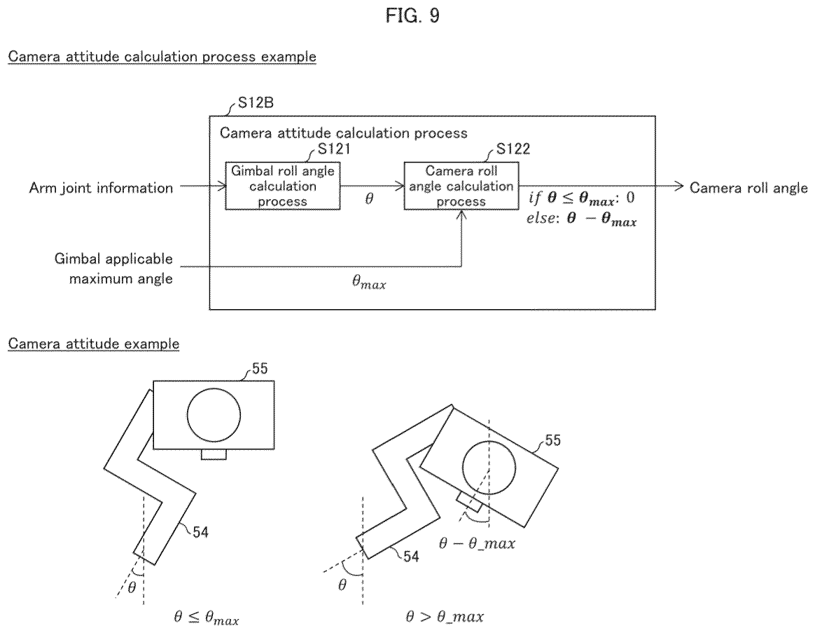

The following will describe another example of the flow of the process carried out by the information processing apparatus 1A with reference to FIGS. 8 and 9. Note that arrows in FIGS. 8 and 9 each merely indicate an example of a direction in which data is moved. Alternatively, data may be moved in the opposite direction or may be moved between constituent elements other than the constituent components which are connected by the arrows.

### Step S12B

First, in step S12B, the second acquisition unit 12 carries out a camera attitude calculation process with reference to at least one selected from the group consisting of gimbal information GI and arm joint information AJI that have been acquired from the robot 50 by the first acquisition unit 11. In the camera attitude calculation process, as an example, the second acquisition unit 12 derives a tilt angle (a camera roll angle in FIG. 8) of the camera 55 described above. In this step, more specifically, the second acquisition unit 12 carries out a process for deriving a tilt angle of the camera 55 with reference to:
Maximum angle information MAI (a limit value of a relative angle between the camera 55 and the gimbal 54) which is included in the gimbal information GI; and
Gimbal tilt information GTI (a tilt of the gimbal 54) which is included in the gimbal information GI.

Here, the tilt of the gimbal 54 may be the one derived by the control section 511 or the control section 20A with reference to the arm joint information AJI.

Alternatively, in this step, the second acquisition unit 12 may be configured to acquire the tilt angle of the camera further with reference to sensing data from the sensor 56 (an acceleration sensor or a gyro sensor) which is attached to the camera 55 or the gimbal 54.

In the example illustrated in FIG. 8, an example is presented in which the roll angle of the camera is calculated as the tilt angle of the camera by the camera attitude calculation process. However, the term “roll angle” is not intended to limit the present example embodiment and may include a tilt angle such as an angle expressed as a “pitch angle”.

FIG. 9 illustrates, in an upper part thereof, a specific example of a camera attitude calculation process in this step. In the example illustrated in the upper part of FIG. 9, a camera attitude calculation process S12B includes a gimbal roll angle calculation process S121 and a camera roll angle calculation process S122.

### Gimbal Roll Angle Calculation Process S121

In the gimbal roll angle calculation process S121, the second acquisition unit 12 calculates a gimbal roll angle θ (the gimbal tilt information GTI described above) from the arm joint information AJI. As an example, the second acquisition unit 12 calculates the gimbal roll angle θ with reference to correspondence information indicating a correspondence between the gimbal roll angle and at least one selected from the group consisting of a tilt of each arm included in the arm joint information AJI and a rotation angle of each joint included in the arm joint information AJI.

### Camera Roll Angle Calculation Process S122

In the camera roll angle calculation process S122, the second acquisition unit 12 derives a camera roll angle (the tilt angle of the camera 55 described above) with reference to:
The gimbal roll angle θ calculated in the gimbal roll angle calculation process S121; and
A gimbal applicable maximum angle θₘₐₓ (the maximum angle information MAI described above).

As an example, the second acquisition unit 12 carries out the following steps S122-1 to S122-3 as the camera roll angle calculation process S122.

### Step S122-1

The second acquisition unit 12 compares the gimbal roll angle θ with the gimbal applicable maximum angle θₘₐₓ. In a case where the second acquisition unit 12 has determined that the gimbal roll angle θ is equal to or less than the gimbal applicable maximum angle θₘₐₓ, that is, in a case where θ≤θₘₐₓ is satisfied, the second acquisition unit 12 proceeds to step S122-2. In a case where the above equation is not satisfied, the second acquisition unit 12 proceeds to step S122-3.

### Step S122-2

In a case where the second acquisition unit 12 has determined in step S122-1 that the gimbal roll angle θ is equal to or less than the gimbal applicable maximum angle θₘₐₓ, the second acquisition unit 12 derives 0 as the camera roll angle in step S122-2. FIG. 9 illustrates, on a left side of a lower part thereof, an example of attitudes of the camera 55 and the gimbal 54 which correspond to the case where 0 is derived as the camera roll angle in this step. As illustrated on the left side of the lower part of FIG. 9, in a case where the gimbal roll angle θ is equal to or less than the gimbal applicable maximum angle θₘₐₓ, the tilt of the camera 55 becomes 0 by a tilt adjustment function of the gimbal 54.

### Step S122-3

In a case where the second acquisition unit 12 has determined in step S122-1 that the gimbal roll angle θ is greater than the gimbal applicable maximum angle θₘₐₓ, the second acquisition unit 12 derives θ−θₘₐₓ as the camera roll angle in step S122-3. FIG. 9 illustrates, on a right side of a lower part thereof, an example of attitudes of the camera 55 and the gimbal 54 which correspond to the case where θ−θₘₐₓ is derived as the camera roll angle in this step. As illustrated on the left side of the lower part of FIG. 9, in a case where the gimbal roll angle θ is greater than the gimbal applicable maximum angle θₘₐₓ, the tilt of the camera 55 does not become 0 by the tilt adjustment function of the gimbal 54, and θ−θₘₐₓ becomes the tilt of the camera 55.

### Steps S13A to S16A

Since steps S13A to S16A illustrated in FIG. 8 are similar to the steps described with reference to FIG. 4, the descriptions thereof will be omitted here.

As described above, carried out in Example 2 of the flow described above are the following processes:
a camera image that has been captured by a camera which is attached to a gimbal is acquired;
a tilt angle of the camera is acquired with reference to at least one selected from the group consisting of the gimbal information GI and the arm joint information AJI (step S12B); and
a tilt-corrected image is generated by applying, to the camera image, a tilt correction process which is carried out with reference to the tilt angle of the camera (step S13A).

According to the above-described configuration, a tilt that can be included in the camera image having been captured by the camera which is attached to the gimbal is s corrected with reference to at least one selected from the group consisting of the gimbal information GI and the arm joint information AJI, and it is thus possible to suitably carry out tilt correction for the camera image. As an example, a tilt in a camera image caused by the tilt of the camera which cannot be completely adjusted even with use of a gimbal can be suitably corrected.

In addition, in Example 2 of the flow described above, the image recognition process is carried out (step S15A) with reference to at least one of the following images:
The tilt-corrected image TCI that has been generated in step S13A; and.
The interpolated image that has been generated in step S14A.

Thus, it is possible to derive a suitable image recognition result.

### Additional Remarks on Examples 1 and 2 of Flow of Process Carried Out by Information Processing Apparatus 1A

The process carried out by the information processing apparatus 1A is not limited to Flow Examples 1 and 2 described above. As an example, the information processing apparatus 1A may be configured to carry out a process in which Flow Examples 1 and 2 described above are combined with each other. For example, the information processing apparatus 1A may be configured to carry out step S12C below instead of step S12A in Flow Example 1 described above and step S12B in the Flow example 2 described above.

### Step S12C

In step S12, the second acquisition unit 12:
derives a first candidate for the tilt angle of the camera 55 with reference to the camera image. (captured image data IMG) (step S12C-1);
derives a second candidate for the tilt angle of the camera 55 with reference to at least one selected from the group consisting of the gimbal information GI and the arm joint information AJI (step S12C-2); and
derives the tilt angle (camera roll angle) of the camera 55 with reference to the first candidate and the second candidate (step S12C-3).

Here, in step S12C-1 described above, as an example, the first candidate for the tilt angle of the camera 55 may be derived by carrying out a process similar to the process in step S12A described above. Further, in step S12C-2 described above, as an example, the second candidate for the tilt angle of the camera 55 may be derived by carrying out a process similar to the process in step S12B described above.

Further, in step S12C-3 described above, as an example,
The tilt angle (camera roll angle) of the camera 55 may be derived by taking a simple average of the first candidate and the second candidate. Alternatively,
The tilt angle (camera roll angle) of the camera 55 may be derived by taking a weighted average of the first candidate and the second candidate.

Here, in a case where the weighted average is used, a configuration may be employed in which the degree of reliability is set to each of the first candidate and the second candidate in advance, and weighted averaging with use of the weight corresponding to the degree of reliability may be carried out.

### Application Example

The information processing system 100A in accordance with the present example embodiment can be applied to various fields, and a specific application example is not intended to limit the present example embodiment. However, for example, the following example can be given.

As an example, the information processing system 100A can be suitably applied to:
An operation of moving or checking a target object by controlling a robot arm to which a camera is attached.

More specifically, the information processing system 100A can be suitably applied to:
A case where warehouse inventory and ledger arrangement are carried out by controlling a robot arm to which a camera is attached.

In such a case, the image processing apparatus 1 in accordance with the present example embodiment:
acquires a camera image that has been captured by a camera which is attached to a robot arm via a gimbal;
acquires a tilt angle of the camera with reference to at least one selected from the group consisting of the camera image and gimbal information which includes a tilt of the gimbal;
generates a tilt-corrected image by applying, to the camera image, a tilt correction process which is carried out with reference to the tilt angle of the camera; and
carries out an image recognition process directly or indirectly with reference to the tilt-corrected image.

Therefore, it is possible to enhance the accuracy of an environment recognition capability by the camera which is attached to the robot arm via the gimbal.

### Software Implementation Example

Some or all of functions of the image processing apparatus 1, the information processing apparatus 1A, and the robot 50 (hereinafter also referred to as “the above-described apparatuses”) can be realized by hardware such as an integrated circuit (IC chip) or can be alternatively realized by software.

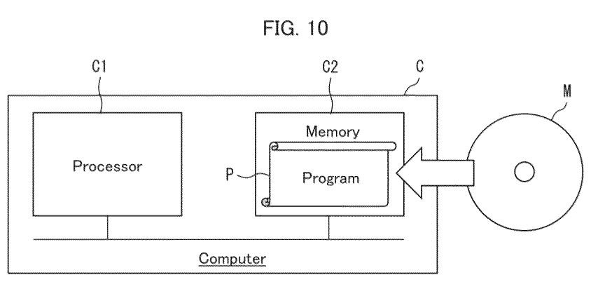

In the latter case, the above-described apparatuses are each realized by, for example, a computer that executes instructions of a program that is software realizing the foregoing functions. FIG. 10 illustrates an example of such a computer (hereinafter referred to as “computer C”). FIG. 10 is a block diagram illustrating a hardware configuration of the computer C that functions as the above-described apparatuses.

The computer C includes at least one processor C1 and at least one memory C2. The at least one memory C2 stores a program P for causing the computer C to operate as the above-described apparatuses. In the computer C, the processor C1 reads the program P from the memory C2 and executes the program P, so that the functions of the above-described apparatuses are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded at the execution of the program P and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark

The present disclosure includes the techniques described in the supplementary notes below. Note, however, that the present invention is not limited to the techniques described in the supplementary notes below, but may be altered in various ways by a skilled person within the scope of the claims.

### Supplementary Note A1

An image processing apparatus including:
a first acquisition means for acquiring a camera image that has been captured by a camera which is attached to a gimbal;
a second acquisition means for acquiring a tilt angle of the camera with reference to at least one selected from the group consisting of the camera image and gimbal information which includes a tilt of the gimbal; and
a tilt correction means for generating a tilt-corrected image by applying, to the camera image, a tilt correction process which is carried out with reference to the tilt angle of the camera.

### Supplementary Note A2

The image processing apparatus described in supplementary note A1, wherein the second acquisition means derives the tilt angle of the camera with reference to the camera image.

### Supplementary Note A3

The image processing apparatus described in supplementary note A1 or A2, wherein:
the gimbal information includes a limit value of a relative angle between the camera and the gimbal; and
the second acquisition means derives the tilt angle of the camera with reference to the tilt of the gimbal and the limit value of the relative angle.

### Supplementary Note A4

The image processing apparatus described in supplementary note A3, wherein the second acquisition means derives the tilt of the gimbal with reference to arm joint information pertaining to a robot arm to which the gimbal is attached.

### Supplementary Note A5

The image processing apparatus described in any one of supplementary notes A1 to A4, wherein the second acquisition means acquires the tilt angle of the camera further with reference to sensing data from an acceleration sensor which is attached to the camera or the gimbal or from a gyro sensor which is attached to the camera or the gimbal.

### Supplementary Note A6

The image processing apparatus described in any one of supplementary notes A1 to A5, further including
an interpolation means for generating an interpolated image by applying an interpolation process to the tilt-corrected image.

### Supplementary Note A7

An information processing apparatus including:
an image processing apparatus described in supplementary note A6;
an image recognition means for applying an image recognition process to the interpolated image; and
an output means for outputting a result of the image recognition process.

### Supplementary Note A8

An information processing apparatus including:
an image processing apparatus described in any one of supplementary notes A1 to A5;
an image recognition means for applying an image recognition process to a tilt-corrected image; and
an output means for outputting a result of the image recognition process.

### Supplementary Note A9

The information processing apparatus described in supplementary note A7, wherein the image recognition means carries out the image recognition process with use of an image recognition model that has been trained with reference to an image group which includes a mask region corresponding to an outside-field-of-view region.

### Supplementary Note A10

An image processing method including:
acquiring a camera image that has been captured by a camera which is attached to a gimbal;
acquiring a tilt angle of the camera with reference to at least one selected from the group consisting of the camera image and gimbal information which includes a tilt of the gimbal; and
generating a tilt-corrected image by applying, to the camera image, a tilt correction process which is carried out with reference to the tilt angle of the camera.

### Supplementary Note A11

A program for causing a computer to function as an image processing apparatus,
the program causing the computer to function as:
a first acquisition means for acquiring a camera image that has been captured by a camera which is attached to a gimbal;
a second acquisition means for acquiring a tilt angle of the camera with reference to at least one selected from the group consisting of the camera image and gimbal information which includes a tilt of the gimbal; and
a tilt correction means for generating a tilt-corrected image by applying, to the camera image, a tilt correction process which is carried out with reference to the tilt angle of the camera.

### REFERENCE SIGNS LIST

1: image processing apparatus
1A: information processing apparatus
11: first acquisition unit
12: second acquisition unit
13: tilt correction unit
14: interpolation unit
15: image recognition unit
16: output unit
100A: information processing system

1. An image processing apparatus comprising at least one first processor, the at least one first processor carrying out:
a first acquisition process for acquiring a camera image that has been captured by a camera which is attached to a gimbal;
a second acquisition process for acquiring a tilt angle of the camera with reference to at least one selected from the group consisting of the camera image and gimbal information which includes a tilt of the gimbal; and
a tilt correction process for generating a tilt-corrected image by applying, to the camera image, tilt correction which is carried out with reference to the tilt angle of the camera.

2. The image processing apparatus according to claim 1, wherein, in the second acquisition process, the at least one first processor derives the tilt angle of the camera with reference to the camera image.

3. The image processing apparatus according to claim 1, wherein:
the gimbal information includes a limit value of a relative angle between the camera and the gimbal; and
in the second acquisition process, the first processor derives the tilt angle of the camera with reference to the tilt of the gimbal and the limit value of the relative angle.

4. The image processing apparatus according to claim 3, wherein, in the second acquisition process, the first processor derives the tilt of the gimbal with reference to arm joint information pertaining to a robot arm to which the gimbal is attached.

5. The image processing apparatus according to claim 1, wherein, in the second acquisition process, the first processor acquires the tilt angle of the camera further with reference to sensing data from an acceleration sensor which is attached to the camera or the gimbal or from a gyro sensor which is attached to the camera or the gimbal.

6. The image processing apparatus according to claim 1, wherein the at least one first processor further carries out an interpolation process for generating an interpolated image by interpolating the tilt-corrected image.

7. An information processing apparatus comprising:
an image processing apparatus according to claim 6; and
at least one second processor, the at least one second processor carrying out:
an image recognition process with respect to the interpolated image; and
an output process for outputting a result of the image recognition process.

8. An information processing apparatus comprising:
an image processing apparatus according to claim 1;
at least one second processor, the at least one second processor carrying out:
an image recognition process with respect to a tilt-corrected image; and
an output process for outputting a result of the image recognition process.

9. An image processing method comprising:
acquiring a camera image that has been captured by a camera which is attached to a gimbal;
acquiring a tilt angle of the camera with reference to at least one selected from the group consisting of the camera image and gimbal information which includes a tilt of the gimbal; and
generating a tilt-corrected image by applying, to the camera image, tilt correction which is carried out with reference to the tilt angle of the camera.

10. A non-transitory storage medium storing a program for causing a computer to function as an image processing apparatus,
the program causing the computer to carry out:
a first acquisition process for acquiring a camera image that has been captured by a camera which is attached to a gimbal;
a second acquisition process for acquiring a tilt angle of the camera with reference to at least one selected from the group consisting of the camera image and gimbal information which includes a tilt of the gimbal; and
a tilt correction process for generating a tilt-corrected image by applying, to the camera image, tilt correction which is carried out with reference to the tilt angle of the camera.
